(19) United States
(12) Patent Application Publication
(10) Pub. No.: US 2020/0396228 A1
(43) Pub. Date: Dec. 17, 2020

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/721,942

(22) Filed: Dec. 20, 2019

(30) Foreign Application Priority Data
Jun. 14, 2019 (JP) 2019-111291

(51) Int. Cl. H04L 29/06; H04L 12/24; G06F 21/44

(52) U.S. Cl. CPC H04L 63/12; G06F 21/44; H04L 41/06

(57) ABSTRACT

An information processing apparatus includes a verification unit, and a permission unit that, if the verification unit verifies that artificial intelligence is connected to a network including plural apparatuses, permits the artificial intelligence to output an instruction to an external apparatus.

### CROSS-REFERENCE TO RELATED APPLICATIONS

This application is based on and claims priority under 35 USC 119 from Japanese Patent Application No. 2019-111291 filed Jun. 14, 2019.

### BACKGROUND

### (i) Technical Field

The present disclosure relates to an information processing apparatus and a non-transitory computer readable medium storing a program.

### (ii) Related Art

Japanese Unexamined Patent Application Publication No. 2017-117226 describes a system that raises artificial intelligence and extracts the raised artificial intelligence.

Japanese Unexamined Patent Application Publication No. 2018-85136 describes a system including a first artificial intelligence module and a second artificial intelligence module. The first artificial intelligence module has a function of assisting or autonomously performing information exchange in an open environment. The second artificial intelligence module monitors an operation of the first artificial intelligence module and autonomously performs processing in a closed environment along with the information exchange.

Japanese Unexamined Patent Application Publication No. 2018-173711 describes an apparatus that provides assist information desired by a customer by using learned artificial intelligence.

### SUMMARY

Aspects of non-limiting embodiments of the present disclosure relate to monitoring of artificial intelligence.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a verification unit, and a permission unit that, if the verification unit verifies that artificial intelligence is connected to a network including a plurality of apparatuses, permits the artificial intelligence to output an instruction to an external apparatus.

### BRIEF DESCRIPTION OF THE DRAWINGS

An exemplary embodiment of the present disclosure will be described in detail based on the following figures, wherein:

FIG. 1 is a block diagram illustrating the configuration of an information processing system according to an exemplary embodiment;

FIG. 2 illustrates an example of a block chain;

FIG. 3 is a block diagram illustrating the configuration of an information processing apparatus according to the exemplary embodiment;

FIG. 4 is a block diagram illustrating the configuration of a device according to the exemplary embodiment; and

FIG. 5 is a flowchart illustrating a flow of processing according to the exemplary embodiment.

### DETAILED DESCRIPTION

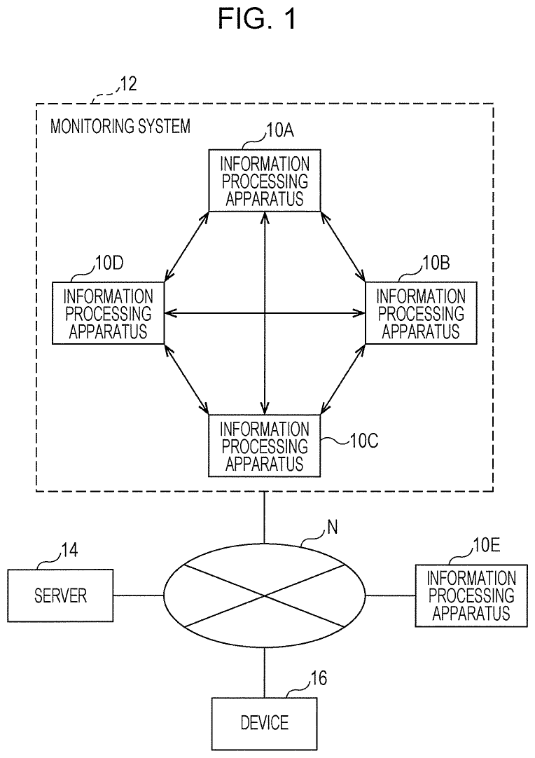

An information processing system according to an exemplary embodiment of the present disclosure is described with reference to FIG. 1. FIG. 1 illustrates an example of the information processing system according to this exemplary embodiment.

The information processing system according to this exemplary embodiment includes a monitoring system 12 including information processing apparatuses 10A, 10B, 10C, and 10D, an information processing apparatus 10E, one or more servers 14, and one or more devices 16. The information processing system according to this exemplary embodiment may include other apparatuses.

The information processing apparatuses 10A, 10B, 10C, 10D, and 10E are hereinafter referred to as “information processing apparatuses 10” unless otherwise distinguished.

The monitoring system 12 includes four information processing apparatuses 10 but the number of information processing apparatuses is an example. The monitoring system 12 only needs to include a plurality of information processing apparatuses 10. The monitoring system 12 may include apparatuses other than the information processing apparatuses 10.

The information processing apparatus 10E is not included in the monitoring system 12. The information processing system may include one or more information processing apparatuses 10 that are not included in the monitoring system 12. Alternatively, the information processing system need not include information processing apparatuses 10 that are not included in the monitoring system 12. Further, the information processing system need not include the server 14 or the device 16.

The information processing apparatus 10, the server 14, and the device 16 may communicate with other apparatuses via a communication path N. Examples of the communication path N include a network such as a local area network (LAN) and the Internet. The communication path N may be built by using wired communication or wireless communication such as Wi-Fi (registered trademark). For example, the information processing apparatus 10, the server 14, and the device 16 are connected to the communication path N by using wireless or wired communication to communicate with other apparatuses via the communication path N. The information processing apparatus 10, the server 14, and the device 16 may communicate with other apparatuses by using close-proximity wireless communication without intervention of the communication path N. Examples of the close-proximity wireless communication include Bluetooth (registered trademark), radio frequency identifiers (RFIDs), and NFC.

The monitoring system 12 monitors artificial intelligence (AI). That is, the information processing apparatuses 10A, 10B, 10C, and 10D included in the monitoring system 12 monitor artificial intelligence.

The artificial intelligence may be installed in one or more information processing apparatuses 10 included in the monitoring system 12, an information processing apparatus 10 that is not included in the monitoring system 12 (e.g., the information processing apparatus 10E), the server 14, or the device 16. That is, a program that implements the artificial intelligence may be stored in the information processing apparatus 10, the server 14, or the device 16. The artificial intelligence may be installed in a different apparatus and monitored by the monitoring system 12. The artificial intelligence may be used by an apparatus other than the apparatus having the artificial intelligence. For example, the artificial intelligence may be installed in the server 14 and used by a PC or other apparatuses. For example, the PC or other apparatuses may use functions of the artificial intelligence installed in the server 14 or services provided by the artificial intelligence.

An algorithm for use in the artificial intelligence is not particularly limited and any algorithm may be used. Examples of the algorithm include machine learning. Examples of machine learning include supervised learning, unsupervised learning, and reinforcement learning. Specific examples include deep learning (e.g., a multilayer perceptron, a convolutional neural network, a recurrent neural network, an autoencoder, and a restricted Boltzmann machine), a perceptron, backpropagation, an associatron, a support vector machine, a decision tree, a k-nearest neighbor method, linear regression, a self-organizing map, a Boltzmann machine, principal component analysis, cluster analysis, and Q-learning. A genetic algorithm or hill climbing may be used as an algorithm other than machine learning. Still other algorithms may be used instead.

Examples of the information processing apparatus 10 include a personal computer (hereinafter referred to as “PC”), a tablet PC, a smartphone, a mobile phone, and a multifunction peripheral with a printing function. The information processing apparatus 10 may be still another apparatus.

The server 14 stores data, transmits data to other apparatuses, and receives data from other apparatuses.

Examples of the device 16 include an information device, a visual device, and an audio device. The device 16 may be any general device. Specific examples of the device 16 include an image forming apparatus with an image forming function, a PC, a tablet PC, a smartphone, a mobile phone, a robot (e.g., a humanoid robot and an animal type robot), a projector, a display device such as a liquid crystal display, a recording device, a reproduction device, an image capturing device such as a camera, a refrigerator, a rice cooker, a microwave oven, a coffee maker, a vacuum cleaner, a washing machine, an air conditioner, a lighting device, a watch or clock, a surveillance camera, an automobile, a two-wheel vehicle, an aerial vehicle (e.g., an unmanned aerial vehicle (so-called drone)), a game console, and various sensing devices (e.g., a temperature sensor, a humidity sensor, a voltage sensor, and a current sensor).

For example, the monitoring system 12 has a peer-to-peer (P2P) configuration in which the information processing apparatuses 10A, 10B, 10C, and 10D communicate with each other. The information processing apparatuses 10A, 10B, 10C, and 10D communicate with each other and synchronize data, thereby sharing data on the same contents. The information processing apparatuses 10A, 10B, 10C, and 10D share the same information by synchronizing information for monitoring artificial intelligence. The information processing apparatuses 10A, 10B, 10C, and 10D monitor artificial intelligence by sharing the information for monitoring artificial intelligence.

For example, the information processing apparatuses 10A, 10B, 10C, and 10D configurate a distributed network that uses a block chain and monitor artificial intelligence by using the block chain. That is, the block chain is used as the information for monitoring artificial intelligence. In the block chain, a plurality of records (e.g., transactions) are linked together. The record indicates an activity performed by artificial intelligence. For example, authenticity of a record is secured by using a hash function and public key cryptography. An apparatus called miner verifies authenticity of a record. If authenticated, the record is organized into a block and contained in the block chain. For example, if artificial intelligence is installed in the information processing apparatus 10E and performs an activity, a record of the activity is transmitted from the information processing apparatus 10E to the monitoring system 12. After authentication, the record is organized into a block and contained in the block chain. The block chain is shared as information on the same contents among the information processing apparatuses 10A, 10B, 10C, and 10D. That is, the information processing apparatuses 10A, 10B, 10C, and 10D share the block chain having the same contents. The information processing apparatuses 10A, 10B, 10C, and 10D monitor the artificial intelligence by sharing the records.

Monitoring software is installed in each of the information processing apparatuses 10A, 10B, 10C, and 10D and the information processing apparatuses 10A, 10B, 10C, and 10D verify and authenticate records. For example, the information processing apparatuses 10A, 10B, 10C, and 10D determine whether an operation of artificial intelligence is normal based on records. Monitoring of artificial intelligence is reinforced as the number of information processing apparatuses 10 that monitor artificial intelligence increases.

Information to be handled by the monitoring system 12 may partially be collected by a centralized apparatus (e.g., the server 14) without being synchronized among the information processing apparatuses 10A, 10B, 10C, and 10D by P2P communication.

The record of an activity performed by artificial intelligence is distributed in and managed by the entire monitoring system 12 as the block chain. That is, a block containing one or more records is sequentially linked to an immediately preceding block and the linked blocks are shared by the information processing apparatuses 10A, 10B, 10C, and 10D.

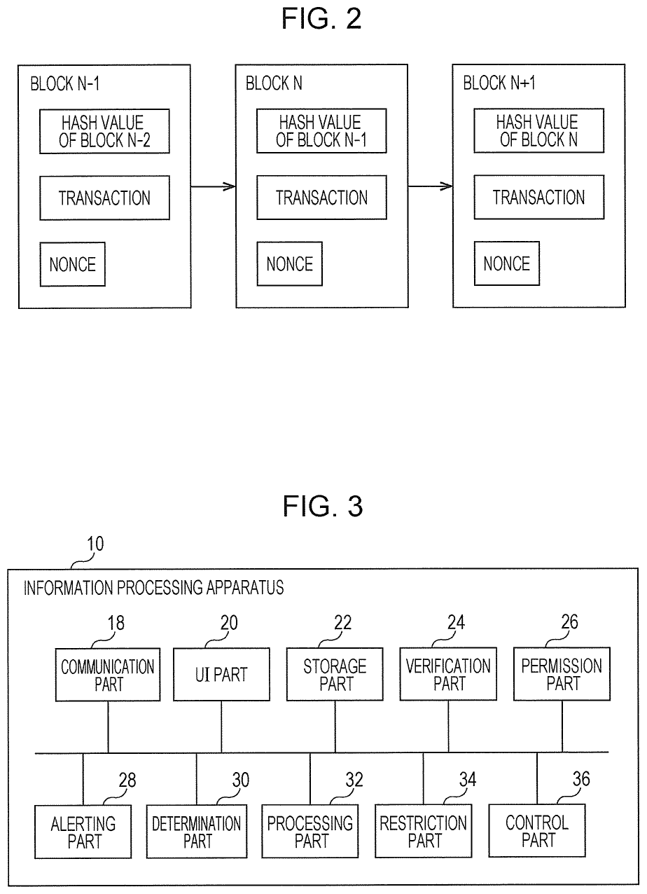

The block is described below with reference to FIG. 2. FIG. 2 illustrates an example of the block. In the example illustrated in FIG. 2, a block N−1, a block N, and a block N+1 are connected in this order. The block N contains a hash value of the block N−1 immediately preceding the block N, a record (transaction) of an activity performed by artificial intelligence, and data called nonce. The record contains artificial intelligence identification information for identifying the artificial intelligence that has performed the activity. A hash value of the block N is generated through calculation by using the three types of data. The hash value is transferred to the block N+1 succeeding the block N. In this manner, the blocks are connected sequentially. If any data in the block is tampered, the hash value changes. The hash values of all the blocks change to different values and therefore the tampered data may be located easily.

For example, the transaction in the block N contains information indicating details of an activity performed by certain artificial intelligence, information indicating a time when the activity is performed, artificial intelligence identification information for identifying the artificial intelligence, apparatus identification information for identifying an apparatus having the artificial intelligence, and user identification information for identifying a user who has given an instruction to perform the activity. The information processing apparatuses 10A, 10B, 10C, and 10D collect and manage one or more records as one block.

The configuration of the information processing apparatus 10 is described below in detail with reference to FIG. 3. FIG. 3 illustrates an example of the configuration of the information processing apparatus 10.

A communication part 18 is a communication interface and has a function of transmitting information to other apparatuses and receiving information from other apparatuses. The communication part 18 may have a wireless communication function or a wired communication function. The communication part 18 may communicate with other apparatuses via the communication path N by using wireless or wired communication. The communication part 18 may communicate with other apparatuses by using close-proximity wireless communication without intervention of the communication path N.

A UI part 20 is a user interface and includes a display part and an operation part. The display part is a display device such as a liquid crystal display. The operation part is an input device such as a keyboard, input keys, or an operation panel. The UI part 20 may be a touch panel serving both as the display part and as the operation part.

A storage part 22 is one or more storage areas that store various types of information. For example, each storage area is configurated by one or more storage devices (e.g., physical drives such as a hard disk drive and a memory) provided in the information processing apparatus 10. The storage part 22 may store a program that implements artificial intelligence.

A verification part 24 verifies whether artificial intelligence is connected to a network including a plurality of apparatuses. Examples of the apparatus include the information processing apparatus 10. Examples of the network include the monitoring system 12. That is, the verification part 24 verifies whether the artificial intelligence is connected to the monitoring system 12. If the artificial intelligence is connected to the monitoring system 12, it is estimated that the artificial intelligence is monitored by the monitoring system 12. If the artificial intelligence is not connected to the monitoring system 12, it is estimated that the artificial intelligence is not monitored by the monitoring system 12.

For example, the verification part 24 may verify whether artificial intelligence specified as verification target artificial intelligence by the user is connected to the monitoring system 12, or whether artificial intelligence is connected to the monitoring system 12 if the artificial intelligence is newly installed in an apparatus.

The state in which artificial intelligence is connected to the monitoring system 12 is a state in which an apparatus having the artificial intelligence is communicable with the monitoring system 12 (that is, the apparatus having the artificial intelligence is connected to the monitoring system 12 and is communicable with any one of the information processing apparatuses 10A, 10B, 10C, and 10D) or a state in which the artificial intelligence is communicable with the monitoring system 12 (that is, the artificial intelligence is connected to the monitoring system 12 and is communicable with the information processing apparatuses 10A, 10B, 10C, and 10D). Monitoring of artificial intelligence is reinforced as the number of information processing apparatuses 10 directly communicable with the apparatus having the artificial intelligence increases.

For example, verification may be made whether the apparatus having the artificial intelligence is communicable with the monitoring system 12 by using a publicly-known technology “ping”. For example, the verification part 24 causes an apparatus having verification target artificial intelligence to transmit transmission information to the monitoring system 12 (e.g., any one of the information processing apparatuses 10A, 10B, 10C, and 10D). Then, the verification part 24 verifies whether reply information to the transmission information is transmitted from the monitoring system 12 to the apparatus and is received by the apparatus. If the apparatus receives the reply information (e.g., the apparatus receives the reply information within a predetermined period), the verification part 24 determines that the apparatus is communicable with the monitoring system 12. If the apparatus has not received the reply information (e.g., the apparatus has not received the reply information within the predetermined period), the verification part 24 determines that the apparatus is not communicable with the monitoring system 12.

For example, artificial intelligence is installed in the information processing apparatus 10E and a verification part 24 of the information processing apparatus 10E verifies whether the artificial intelligence is connected to the monitoring system 12.

The verification part 24 of the information processing apparatus 10E transmits transmission information to the monitoring system 12. If reply information to the transmission information is transmitted from the monitoring system 12 to the information processing apparatus 10E and is received by the communication part 18 of the information processing apparatus 10E, the verification part 24 of the information processing apparatus 10E determines that the artificial intelligence installed in the information processing apparatus 10E is connected to the monitoring system 12. That is, the verification part 24 of the information processing apparatus 10E determines that the artificial intelligence installed in the information processing apparatus 10E is monitored by the monitoring system 12.

If the reply information is not received by the communication part 18 of the information processing apparatus 10E, the verification part 24 of the information processing apparatus 10E determines that the artificial intelligence installed in the information processing apparatus 10E is not connected to the monitoring system 12. That is, the verification part 24 of the information processing apparatus 10E determines that the artificial intelligence installed in the information processing apparatus 10E is not monitored by the monitoring system 12.

Verification may be made whether artificial intelligence is connected to the monitoring system 12 if the artificial intelligence is installed in any one of the information processing apparatuses 10A, 10B, 10C, and 10D. Since the information processing apparatuses 10A, 10B, 10C, and 10D are included in the monitoring system 12, determination is made that the artificial intelligence is connected to the monitoring system 12. The determination may be made by a verification part 24 of an information processing apparatus 10 having the artificial intelligence out of the information processing apparatuses 10A, 10B, 10C, and 10D, or by a verification part 24 of an information processing apparatus 10 without the artificial intelligence out of the information processing apparatuses 10A, 10B, 10C, and 10D.

Verification may be made whether artificial intelligence is connected to the monitoring system 12 if the artificial intelligence is installed in the server 14. For example, if the information processing apparatus 10E is communicable with the server 14 via the communication path N, the verification part 24 of the information processing apparatus 10E verifies whether the artificial intelligence installed in the server 14 is connected to the monitoring system 12. The verification part 24 of the information processing apparatus 10E causes the server 14 to transmit transmission information to the monitoring system 12. The verification part 24 of the information processing apparatus 10E verifies whether the server 14 receives reply information to the transmission information from the monitoring system 12. For example, if the server 14 receives the reply information from the monitoring system 12, information indicating the reception is transmitted from the server 14 to the information processing apparatus 10E. In this case, the verification part 24 of the information processing apparatus 10E determines that the artificial intelligence installed in the server 14 is connected to the monitoring system 12. If the information indicating the reception is not transmitted from the server 14 to the information processing apparatus 10E, the verification part 24 of the information processing apparatus 10E determines that the artificial intelligence installed in the server 14 is not connected to the monitoring system 12. The same applies to a case where artificial intelligence is installed in the device 16.

The verification part 24 may register, in an alert list, identification information for identifying artificial intelligence that is not connected to the monitoring system 12. For example, data on the alert list may be stored in the storage part 22 of the information processing apparatus 10 or an apparatus other than the information processing apparatus 10 (e.g., the server 14).

A permission part 26 permits or prohibits artificial intelligence to output or from outputting an instruction to an external apparatus. If the verification part 24 determines that verification target artificial intelligence is connected to the monitoring system 12, the permission part 26 permits the artificial intelligence to output an instruction to an external apparatus. In this case, the permission part 26 may associate permission information with the artificial intelligence. The permission information indicates that the artificial intelligence is permitted to output an instruction to an external apparatus. For example, the permission part 26 gives the permission information to the artificial intelligence as supplementary information. If the verification part 24 determines that the verification target artificial intelligence is not connected to the monitoring system 12, the permission part 26 prohibits the artificial intelligence from outputting an instruction to an external apparatus. In this case, the permission part 26 may associate prohibition information with the artificial intelligence. The prohibition information indicates that the artificial intelligence is prohibited from outputting an instruction to an external apparatus. For example, the permission part 26 gives the prohibition information to the artificial intelligence as supplementary information.

The external apparatus may be an apparatus included in the information processing system according to this exemplary embodiment or an apparatus that is not included in the information processing system according to this exemplary embodiment. Examples of the external apparatus include the device 16.

If the verification target artificial intelligence is installed in an information processing apparatus 10, a permission part 26 of the information processing apparatus 10 having the verification target artificial intelligence permits or prohibits the artificial intelligence installed in the information processing apparatus 10 to output or from outputting an instruction to an external apparatus depending on a verification result from the verification part 24 of the information processing apparatus 10E. If the verification target artificial intelligence is installed in the server 14 or the device 16, a permission part 26 of the information processing apparatus 10E permits or prohibits the artificial intelligence installed in the server 14 or the device 16 to output or from outputting an instruction to an external apparatus depending on a verification result from the verification part 24 of the information processing apparatus 10E.

An alerting part 28 outputs an alert depending on the number of information processing apparatuses 10 included in the monitoring system 12. For example, the alerting part 28 may output an alert if the number of information processing apparatuses 10 included in the monitoring system 12 decreases by a predetermined value or becomes equal to or smaller than a predetermined threshold. If the number of information processing apparatuses 10 that monitor artificial intelligence decreases, monitoring of artificial intelligence may be weakened.

For example, the alerting part 28 may cause the display part of the UI part 20 to display information indicating an alert, cause a loudspeaker to sound an alert, or transmit information indicating an alert to an apparatus other than the information processing apparatus 10 (e.g., an apparatus having verification target artificial intelligence).

For example, an alerting part 28 of each of the information processing apparatuses 10A, 10B, 10C, and 10D included in the monitoring system 12 may count information processing apparatuses 10 included in the monitoring system 12 and output an alert depending on a counting result. Alternatively, the information processing apparatus 10E may count information processing apparatuses 10 included in the monitoring system 12 and output an alert depending on a counting result.

A determination part 30 determines whether an operation of artificial intelligence monitored by the monitoring system 12 is abnormal based on records in the block chain. For example, the determination part 30 determines whether an operation of artificial intelligence is abnormal based on the number of records in each block or based on whether a record is present. The determination part 30 may monitor artificial intelligence based on records.

For example, if the number of records in a block is equal to or larger than a predetermined threshold, the determination part 30 determines that an operation of artificial intelligence that has performed activities indicated by the records is abnormal. The threshold may be determined depending on details of the activity performed by the artificial intelligence. If the operation of the artificial intelligence is abnormal, the number of records may be larger than in a case where the operation of the artificial intelligence is normal. For example, the number of records may increase because an inappropriate activity is performed. Determination may be made whether the operation of the artificial intelligence is abnormal by comparing the number of records and the threshold determined depending on the activities.

If any activity is performed, information related to the activity may be contained in a block as a record. If the block contains no information related to the activity, the determination part 30 may determine that the operation of the artificial intelligence is abnormal.

For example, information indicating a determination result from the determination part 30 may be displayed on the display part of the UI part 20, output as sound or voice, or transmitted to other apparatuses.

A processing part 32 executes processing of stopping an operation of artificial intelligence or deleting the artificial intelligence if the artificial intelligence is disconnected from the monitoring system 12. The artificial intelligence whose operation is stopped does not perform an activity even if instructed to perform the activity. In the processing of deleting the artificial intelligence, a program that implements the artificial intelligence is deleted from an apparatus having the artificial intelligence. Which of the processing of stopping the operation and the processing of deleting the artificial intelligence is executed may be specified by the user or specified in advance. Whether the artificial intelligence is disconnected from the monitoring system 12 is verified by the verification part 24. If the verification part 24 determines that the artificial intelligence is disconnected from the monitoring system 12, the processing part 32 executes the processing of stopping the operation of the artificial intelligence or deleting the artificial intelligence. The verification may be made by the verification part 24 at a predetermined timing, periodically, or at a timing specified by the user of the artificial intelligence. The case where the artificial intelligence is disconnected from the monitoring system 12 is a case where the artificial intelligence was connected to the monitoring system 12 but is not connected when the verification is made by the verification part 24, or a case where the artificial intelligence is not connected to the monitoring system 12 from the beginning.

If the processing part 32 has stopped the operation of the artificial intelligence or deleted the artificial intelligence, the communication part 18 may transmit, to a management apparatus, information related to the apparatus in which the artificial intelligence was installed. In this case, the communication part 18 corresponds to an example of a transmission unit.

The management apparatus may be the server 14 or other apparatuses.

Examples of the information related to the apparatus having the artificial intelligence include apparatus identification information for identifying the apparatus (e.g., a MAC address, a model number, and an IP address) and user identification information for identifying the user of the apparatus (e.g., a user name and a user ID).

The management apparatus stores a recovery artificial intelligence program. The recovery artificial intelligence program is a program that restores artificial intelligence whose operation is stopped, or a program that reinstalls deleted artificial intelligence in an apparatus. If the recovery artificial intelligence program is transmitted from the management apparatus to the apparatus in which the artificial intelligence was installed previously and is installed in the apparatus, the artificial intelligence resumes the operation or the deleted artificial intelligence is reinstalled in the apparatus. The management apparatus may transmit the recovery artificial intelligence program to the apparatus if the apparatus is connected to the monitoring system 12. For example, the management apparatus transmits the recovery artificial intelligence program to the apparatus if the apparatus transmits, to the management apparatus, information indicating that the apparatus is connected to the monitoring system 12.

At least one apparatus out of the information processing apparatuses 10A, 10B, 10C, and 10D included in the monitoring system 12 may be an apparatus without artificial intelligence. If artificial intelligence monitors other artificial intelligence, the performance of the monitoring artificial intelligence may be inferior to the performance of the monitored artificial intelligence. In this case, the monitoring artificial intelligence may fail to monitor the other artificial intelligence appropriately.

For example, a half or more of the plurality of information processing apparatuses 10 included in the monitoring system 12 may be information processing apparatuses 10 without artificial intelligence. A predetermined number or more of the plurality of information processing apparatuses 10 included in the monitoring system 12 may be information processing apparatuses 10 without artificial intelligence. A predetermined number or less of the plurality of information processing apparatuses 10 included in the monitoring system 12 may be information processing apparatuses 10 having artificial intelligence.

A restriction part 34 restricts output of an operation execution instruction from authentication target artificial intelligence to an external apparatus until authentication of the artificial intelligence is finished. The external apparatus is an apparatus (e.g., the device 16) other than an apparatus having the authentication target artificial intelligence.

For example, the information processing apparatus 10 or any other apparatus (e.g., the server 14 or an authentication server) stores identification information for identifying artificial intelligence permitted to output an operation execution instruction to an external apparatus. The restriction part 34 receives identification information of authentication target artificial intelligence and authenticates the artificial intelligence based on the identification information. If the identification information of the authentication target artificial intelligence is stored in the information processing apparatus 10 or the other apparatus as the identification information of the artificial intelligence permitted to output an operation execution instruction to an external apparatus, the authentication is successful and the restriction part 34 permits the authentication target artificial intelligence to output an execution instruction. If the identification information of the authentication target artificial intelligence is not stored in the information processing apparatus 10 or the other apparatus as the identification information of the artificial intelligence permitted to output an operation execution instruction to an external apparatus, the authentication is unsuccessful and the restriction part 34 prohibits the authentication target artificial intelligence from outputting an execution instruction. The restriction part 34 transmits information indicating a result of the authentication processing to the apparatus having the authentication target artificial intelligence.

If the authentication is successful, the authentication target artificial intelligence is permitted to output an operation execution instruction to an external apparatus. In this case, the authentication target artificial intelligence outputs the operation execution instruction to the external apparatus. If the authentication is unsuccessful, the authentication target artificial intelligence is prohibited from outputting an operation execution instruction to an external apparatus. In this case, the authentication target artificial intelligence is not permitted to output the operation execution instruction to the external apparatus. The authentication processing for artificial intelligence may be performed by an apparatus other than the information processing apparatus 10 (e.g., the server 14 or the authentication server).

For example, an apparatus having artificial intelligence includes a detection unit that detects that the artificial intelligence is started. If the artificial intelligence is started, identification information of the artificial intelligence is transmitted from the apparatus to the information processing apparatus 10 for authentication of the artificial intelligence. The restriction part 34 executes authentication processing based on the identification information of the artificial intelligence. Examples of the artificial intelligence include artificial intelligence that autonomously outputs an operation execution instruction to an external apparatus (e.g., artificial intelligence that outputs the operation execution instruction by making determination without receiving an instruction from the user). The artificial intelligence may operate by receiving information. The authentication processing may be executed in response to transmission of the identification information of the artificial intelligence from the apparatus having the artificial intelligence to the information processing apparatus 10 when the apparatus is powered ON.

A control part 36 controls operations of the respective parts of the information processing apparatus 10.

The configuration of the device 16 is described below. If artificial intelligence is connected to a network including a plurality of apparatuses, the artificial intelligence outputs an operation execution instruction to the device 16. In response to reception of the execution instruction, the device 16 operates based on the execution instruction. The artificial intelligence may be installed in an apparatus other than the device 16 that receives the operation execution instruction (e.g., a PC or the server 14), a device 16 other than the device 16 that receives the operation execution instruction, or the device 16 that receives the operation execution instruction.

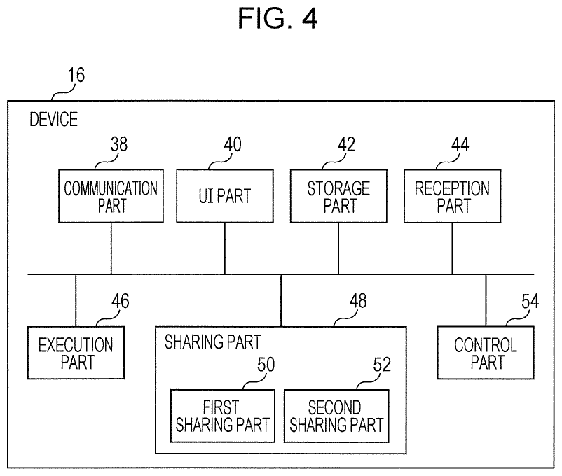

The configuration of the device 16 is described below in detail with reference to FIG. 4. FIG. 4 illustrates an example of the configuration of the device 16.

A communication part 38 is a communication interface and has a function of transmitting information to other apparatuses and receiving information from other apparatuses. The communication part 38 may have a wireless communication function or a wired communication function. The communication part 38 may communicate with other apparatuses via the communication path N by using wireless or wired communication. The communication part 38 may communicate with other apparatuses by using close-proximity wireless communication without intervention of the communication path N.

A UI part 40 is a user interface and includes a display part and an operation part. The display part is a display device such as a liquid crystal display. The operation part is an input device such as a keyboard, input keys, or an operation panel. The UI part 40 may be a touch panel serving both as the display part and as the operation part.

A storage part 42 is one or more storage areas that store various types of information. For example, each storage area is configurated by one or more storage devices (e.g., physical drives such as a hard disk drive and a memory) provided in the device 16. The storage part 42 may store a program that implements artificial intelligence.

A reception part 44 receives an operation execution instruction for the device 16 to which the reception part 44 belongs. The reception part 44 may receive the execution instruction from an apparatus (e.g., a different device 16, the server 14, or the information processing apparatus 10) other than the device 16 to which the reception part 44 belongs, or from the device 16 to which the reception part 44 belongs. For example, the reception part 44 receives an operation execution instruction for the device 16 to which the reception part 44 belongs when artificial intelligence outputs the execution instruction to the device 16.

In response to the reception part 44 receiving an execution instruction, an execution part 46 executes a function of the device 16 based on the execution instruction. For example, if the device 16 to which the execution part 46 belongs is a printer and the reception part 44 receives a printing execution instruction, the execution part 46 executes printing.

If the reception part 44 receives an operation execution instruction from artificial intelligence connected to the monitoring system 12, the execution part 46 may execute an operation based on the execution instruction. If the reception part 44 receives an operation execution instruction from artificial intelligence that is not connected to the monitoring system 12, the execution part 46 need not execute an operation based on the execution instruction. That is, if the verification part 24 of the information processing apparatus 10 verifies that artificial intelligence that has output an operation execution instruction to the device 16 to which the execution part 46 belongs is connected to the monitoring system 12, in other words, if the permission part 26 of the information processing apparatus 10 permits the artificial intelligence to output an instruction to an external apparatus, the execution part 46 executes an operation based on the execution instruction. If the verification part 24 of the information processing apparatus 10 does not verify that artificial intelligence that has output an operation execution instruction to the device 16 to which the execution part 46 belongs is connected to the monitoring system 12, in other words, if the permission part 26 of the information processing apparatus 10 prohibits the artificial intelligence from outputting an instruction to an external apparatus, the execution part 46 does not execute an operation based on the execution instruction.

For example, if artificial intelligence associated with permission information outputs an operation execution instruction to the device 16, the artificial intelligence outputs the execution instruction to the device 16 together with the permission information. If the reception part 44 receives the execution instruction together with the permission information, the execution part 46 executes an operation based on the execution instruction.

If artificial intelligence that is not associated with permission information outputs an execution instruction to the device 16, the artificial intelligence fails to output the permission information and outputs the execution instruction to the device 16 without the permission information. If the reception part 44 receives the execution instruction without the permission information, the execution part 46 does not execute an operation based on the execution instruction.

The reception part 44 may receive an operation execution instruction from artificial intelligence connected to the monitoring system 12, but need not receive an operation execution instruction from artificial intelligence that is not connected to the monitoring system 12. That is, if the verification part 24 of the information processing apparatus 10 verifies that artificial intelligence that has output an operation execution instruction to the device 16 to which the reception part 44 belongs is connected to the monitoring system 12, in other words, if the permission part 26 of the information processing apparatus 10 permits the artificial intelligence to output an instruction to an external apparatus, the reception part 44 receives the operation execution instruction from the artificial intelligence. If the verification part 24 of the information processing apparatus 10 does not verify that artificial intelligence that has output an operation execution instruction to the device 16 to which the reception part 44 belongs is connected to the monitoring system 12, in other words, if the permission part 26 of the information processing apparatus 10 prohibits the artificial intelligence from outputting an instruction to an external apparatus, the reception part 44 does not receive the operation execution instruction from the artificial intelligence.

For example, if artificial intelligence associated with permission information outputs an operation execution instruction to the device 16, the artificial intelligence outputs the execution instruction to the device 16 together with the permission information. The reception part 44 receives the execution instruction together with the permission information.

If artificial intelligence that is not associated with permission information outputs an execution instruction to the device 16, the artificial intelligence fails to output the permission information and outputs the execution instruction to the device 16 without the permission information. The reception part 44 does not receive the execution instruction without the permission information.

A sharing part 48 includes a first sharing part 50 and a second sharing part 52 and shares information with other apparatuses. The other apparatuses may be apparatuses included in the information processing system according to this exemplary embodiment (e.g., the information processing apparatuses 10, the server 14, and other devices 16) or apparatuses that are not included in the information processing system. The other apparatuses with which the sharing part 48 shares information are preset and information related to the other apparatuses is prestored in the storage part 42. Examples of the information related to the other apparatuses include information indicating addresses of the other apparatuses (e.g., IP addresses and MAC addresses).

The first sharing part 50 shares, with the other apparatuses, information on artificial intelligence that is not connected to the monitoring system 12 (e.g., identification information of the artificial intelligence). For example, if the reception part 44 receives an execution instruction from artificial intelligence that is not connected to the monitoring system 12, that is, if the reception part 44 receives an execution instruction from the artificial intelligence without permission information, the first sharing part 50 transmits identification information of the artificial intelligence to the other apparatuses to share the identification information of the artificial intelligence with the other apparatuses. For example, the first sharing part 50 transmits the identification information of the artificial intelligence to the other apparatuses by using the information indicating the addresses of the other apparatuses to share the identification information of the artificial intelligence with the other apparatuses.

If the reception part 44 receives an operation execution instruction from artificial intelligence, the second sharing part 52 shares, with the other apparatuses, notification information indicating that the reception part 44 receives the execution instruction from the artificial intelligence. The artificial intelligence may be artificial intelligence connected to the monitoring system 12 or artificial intelligence that is not connected to the monitoring system 12. Examples of the notification information include identification information of the artificial intelligence and information indicating details of operation. For example, the second sharing part 52 transmits the notification information to the other apparatuses by using the information indicating the addresses of the other apparatuses to share the notification information with the other apparatuses.

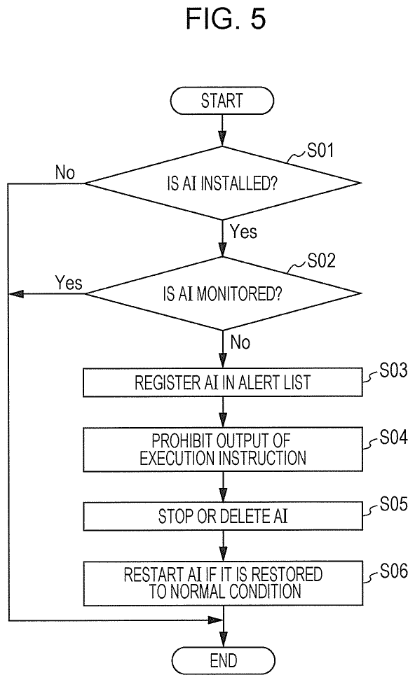

A flow of processing according to this exemplary embodiment is described below with reference to FIG. 5. FIG. 5 is a flowchart illustrating an example of the flow of processing according to this exemplary embodiment.

If artificial intelligence (“AI” in FIG. 5) is not installed in a verification target apparatus (“No” in S01), the processing is terminated. For example, the verification target apparatus is specified by the user. The verification target apparatus may be the information processing apparatus 10, the server 14, the device 16, or other apparatuses.

If artificial intelligence is installed in the verification target apparatus (“Yes” in S01), the verification part 24 verifies whether the artificial intelligence installed in the verification target apparatus is connected to the monitoring system 12 (S02). That is, the verification part 24 verifies whether the artificial intelligence installed in the verification target apparatus is monitored by the monitoring system 12.

If the artificial intelligence installed in the verification target apparatus is connected to the monitoring system 12, that is, if the artificial intelligence installed in the verification target apparatus is monitored by the monitoring system 12 (“Yes” in S02), the processing is terminated. In this case, the permission part 26 permits the artificial intelligence to output an instruction to an external apparatus.

If the artificial intelligence installed in the verification target apparatus is not connected to the monitoring system 12, that is, if the artificial intelligence installed in the verification target apparatus is not monitored by the monitoring system 12 (“No” in S02), the verification part 24 registers identification information of the artificial intelligence in an alert list (S03).

The permission part 26 prohibits the artificial intelligence installed in the verification target apparatus from outputting an instruction to an external apparatus (S04).

The processing part 32 stops an operation of the artificial intelligence installed in the verification target apparatus or deletes a program of the artificial intelligence (S05).

If the artificial intelligence whose operation is stopped or the deleted artificial intelligence is restored to a normal condition, the artificial intelligence is restarted (S06). For example, if the artificial intelligence whose operation is stopped is connected to the monitoring system 12, the permission part 26 permits the artificial intelligence to output an instruction to an external apparatus. In this case, the artificial intelligence is restarted because the artificial intelligence is restored to the normal condition. If the program of the deleted artificial intelligence is transmitted to the apparatus in which the deleted artificial intelligence was installed previously and is installed in the apparatus, the artificial intelligence is restarted because the artificial intelligence is restored to the normal condition.

If an apparatus having artificial intelligence performs an operation different from a predetermined operation, the control part 36 of the information processing apparatus 10 may stop an operation of the artificial intelligence or delete a program of the artificial intelligence. For example, if an apparatus having artificial intelligence connected to the monitoring system 12 performs an operation different from a predetermined operation, the control part 36 may stop an operation of the artificial intelligence or delete a program of the artificial intelligence. The apparatus having the artificial intelligence transmits information indicating the operation of the apparatus to the information processing apparatus 10 and the control part 36 recognizes the operation of the apparatus based on the information indicating the operation. If artificial intelligence is installed in the device 16 and the device 16 performs an operation different from a predetermined operation, a control part 54 of the device 16 may stop an operation of the artificial intelligence or delete a program of the artificial intelligence.

For example, each of the apparatuses described above (information processing apparatus 10, server 14, and device 16) is implemented by cooperation between hardware and software. Specifically, each apparatus includes one or more processors such as CPUs (not illustrated). The one or more processors read and execute a program stored in a storage device (not illustrated) to implement the functions of the respective parts of each apparatus. The program is stored in the storage device via a recording medium such as a CD or a DVD or via a communication path such as a network. As another example, the respective parts of each apparatus may be implemented by hardware resources such as a processor, an electronic circuit, or an application specific integrated circuit (ASIC). A device such as a memory may be used for the implementation. As still another example, the respective parts of each apparatus may be implemented by a digital signal processor (DSP) or a field programmable gate array (FPGA).

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus, comprising:
a verification unit; and
a permission unit that, if the verification unit verifies that artificial intelligence is connected to a network including a plurality of apparatuses, permits the artificial intelligence to output an instruction to an external apparatus.

2. The information processing apparatus according to claim 1, wherein the plurality of apparatuses that configurate the network synchronize data.

3. The information processing apparatus according to claim 2, further comprising an alerting unit that outputs an alert if a number of the plurality of apparatuses decreases by a predetermined value.

4. The information processing apparatus according to claim 2, further comprising an alerting unit that outputs an alert if a number of the plurality of apparatuses becomes equal to or smaller than a predetermined threshold.

5. The information processing apparatus according to claim 2, wherein the network is a network that uses a block chain.

6. The information processing apparatus according to claim 5,
wherein the block chain comprises records of activities performed by the artificial intelligence, and
wherein the information processing apparatus further comprises a determination unit that determines whether operation of the artificial intelligence is abnormal based on the records.

7. The information processing apparatus according to claim 6,
wherein the determination unit determines whether operation of the artificial intelligence is abnormal based on the number of records in a block of the block chain.

8. The information processing apparatus according to claim 1, further comprising a processing unit that executes processing of stopping an operation of the artificial intelligence or deleting the artificial intelligence if the artificial intelligence is disconnected from the network.

9. The information processing apparatus according to claim 8, further comprising a transmission unit that, if the operation of the artificial intelligence is stopped or the artificial intelligence is deleted, transmits, to a management apparatus, information related to an apparatus in which the artificial intelligence was installed.

10. The information processing apparatus according to claim 9, wherein a recovery artificial intelligence program is transmitted from the management apparatus to the apparatus in which the artificial intelligence was installed.

11. The information processing apparatus according to claim 1, wherein no artificial intelligence is installed in at least one apparatus out of the plurality of apparatuses.

12. The information processing apparatus according to claim 1,
wherein the artificial intelligence has a function of outputting an operation execution instruction to the external apparatus, and
wherein the information processing apparatus further comprises a restriction unit that restricts output of the operation execution instruction from the artificial intelligence to the external apparatus until authentication of the artificial intelligence is finished.

13. An information processing apparatus, comprising:
a reception unit; and
an execution unit that, in response to the reception unit receiving an operation execution instruction from artificial intelligence connected to a network including a plurality of apparatuses, executes an operation based on the operation execution instruction.

14. The information processing apparatus according to claim 13, wherein the plurality of apparatuses that configurate the network synchronize data.

15. The information processing apparatus according to claim 14, wherein the network is a network that uses a block chain.

16. The information processing apparatus according to claim 13, further comprising a first sharing unit that shares, with a different apparatus, information on artificial intelligence that is not connected to the network.

17. The information processing apparatus according to claim 13, wherein the reception unit does not receive an operation execution instruction from artificial intelligence that is not connected to the network.

18. The information processing apparatus according to claim 13, wherein, if the reception unit receives an operation execution instruction from artificial intelligence that is not connected to the network, the execution unit does not execute an operation based on the operation execution instruction received from the artificial intelligence that is not connected to the network.

19. The information processing apparatus according to claim 13, further comprising a second sharing unit that, if the reception unit receives the operation execution instruction from the artificial intelligence, shares, with a different apparatus, information indicating that the reception unit receives the operation execution instruction from the artificial intelligence.

20. A non-transitory computer readable medium storing a program causing a computer to execute a process comprising:
permitting, if verification is made that artificial intelligence is connected to a network including a plurality of apparatuses, the artificial intelligence to output an instruction to an external apparatus.

21. A non-transitory computer readable medium storing a program causing a computer to execute a process comprising:
executing, in response to reception of an operation execution instruction from artificial intelligence connected to a network including a plurality of apparatuses, an operation based on the operation execution instruction.
